(19) United States
(12) Patent Application Publication
(10) Pub. No.: US 2026/0065000 A1
(43) Pub. Date: Mar. 5, 2026

(54) ANTI-SKIMMING DEVICE

(71) Applicant: MASTERCARD INTERNATIONAL INCORPORATED, Purchase, NY (US)

(72) Inventor: Ravi KANWAR, North York (CA)

(73) Assignee: MASTERCARD INTERNATIONAL INCORPORATED, Purchase, NY (US)

(21) Appl. No.: 18/816,554

(22) Filed: Aug. 27, 2024

(51) Int. Cl. G06K 7/00; G06K 7/08

(52) U.S. Cl. CPC G06K 7/0095; G06K 7/087

(57) ABSTRACT

The disclosure relates to anti-skimming countermeasures against skimming devices placed on card acceptor devices. The anti-skimming countermeasures may be active and/or passive. An active anti-skimming countermeasure is one in which the physical state of the card acceptor device is altered and the user is required to accurately describe the altered physical state. An incorrect user response suggests that a skimming device is present. A passive anti-skimming countermeasure is one in which the card acceptor device includes one or more static physical features that make the presence of a skimming device more apparent to a user.

### BACKGROUND

A skimming device is hardware that is secretly placed on a card acceptor device to intercept payment card numbers, keystrokes, or other inputs to steal this data. Card acceptor devices can include devices such as an Automated Teller Machine (ATM), a Point of Sale (POS) device, a fuel dispenser, or other device that accepts payment cards. Typically, skimming devices are placed on top of one or more parts of a card acceptor device to steal data. For example, a skimming device can be placed on top of strip readers to read magnetic strips as they are swiped, Document Insertion Processor (DIP) readers to read chips as they are inserted, keypads to record keystrokes such as Personal Identification Number (PIN) inputs, and/or other parts of a card acceptor device. To this end, skimming devices are usually manufactured in a manner to fit the card acceptor device so that a user is unaware of its presence.

### BRIEF DESCRIPTION OF THE DRAWINGS

Features of the present disclosure may be illustrated by way of example and not limited in the following figure(s), in which like numerals indicate like elements, in which:

FIG. 1 illustrates an example of a card acceptor device with one or more active anti-skimming countermeasures;

FIG. 2 illustrates an example of a method of altering a physical state of a card acceptor device and a challenge-response relating to the altered physical state to detect the presence of a skimming device;

FIG. 3A illustrates an example of altering the physical state of a card acceptor device by changing the configuration of the keypad, as shown in a top-down view;

FIG. 3B illustrates an example of altering the physical state of a card acceptor device by changing the protrusion, or elevation, of one or more keys in the keypad relative to one or more other keys in the keypad, as shown in a side-elevational view;

FIG. 4 illustrates an example of a prompt in a challenge-response corresponding to an altered physical state using a track arrangement illustrated in FIG. 3A;

FIG. 5 illustrates an example of altering the physical state of a card acceptor device by changing a shape of a DIP reader;

FIG. 6 illustrates an example of a prompt in a challenge-response corresponding to an altered physical state illustrated in FIG. 5;

FIG. 7A illustrates an example of a skimming device placed on a keypad having a conventional arrangement of keys on the same side elevational plane, as shown in a side-elevational view;

FIG. 7B illustrates an example of a static anti-skimming countermeasure using a fixed keypad with different elevations, as shown in a side-elevational view;

FIG. 8 illustrates an example of a system environment that includes a card acceptor device with anti-skimming countermeasures; and

FIG. 9 illustrates an example of a computer system that may be implemented by devices illustrated in FIG. 1.

### DETAILED DESCRIPTION

The disclosure relates to anti-skimming countermeasures against skimming devices placed on card acceptor devices. The anti-skimming countermeasures may include active and/or passive countermeasures. An active anti-skimming countermeasure is one in which a physical state of card acceptor device is altered and the user is prompted to provide an input that accurately describes the physical state. For example, a card acceptor device may include a keypad that is coupled to one or more motors that alter its key configuration, key height, and/or other physical state. In another example, a card reader slot may be moved to alter its shape such as by variably retracting or extending portions thereof. In either or both of these examples, the card acceptor device may prompt a user to answer a challenge question about the physical state of the card acceptor device, such as the configuration of the keypad and/or the card reader slot. Other types of alterations to the physical state of the card acceptor device and corresponding challenge-response may be made. An incorrect user response suggests that a skimming device is present, in which case the user may be alerted. In some instances, the card acceptor device may transmit, to an operator of the card acceptor device, an alert that the card acceptor device should be inspected.

A passive anti-skimming countermeasure is one in which the card acceptor device includes one or more static physical features that make the presence of a skimming device more apparent to a user. For example, a keypad may be manufactured with keys on different elevational heights. In particular, one or more keys may be higher than another set of keys. In one example, rows or columns of keys in the keypad may be manufactured to be at different heights relative to one another. These and other types of static physical features may make the presence of skimming devices more noticeable, deterring their application on the card acceptor device. To further deter skimming devices being custom-designed for passive anti-skimming countermeasures, different card acceptor devices may be manufactured with different passive anti-skimming countermeasures. This may make it less likely that a single or even set of skimming devices can or will be custom made to fit different passive anti-skimming countermeasures.

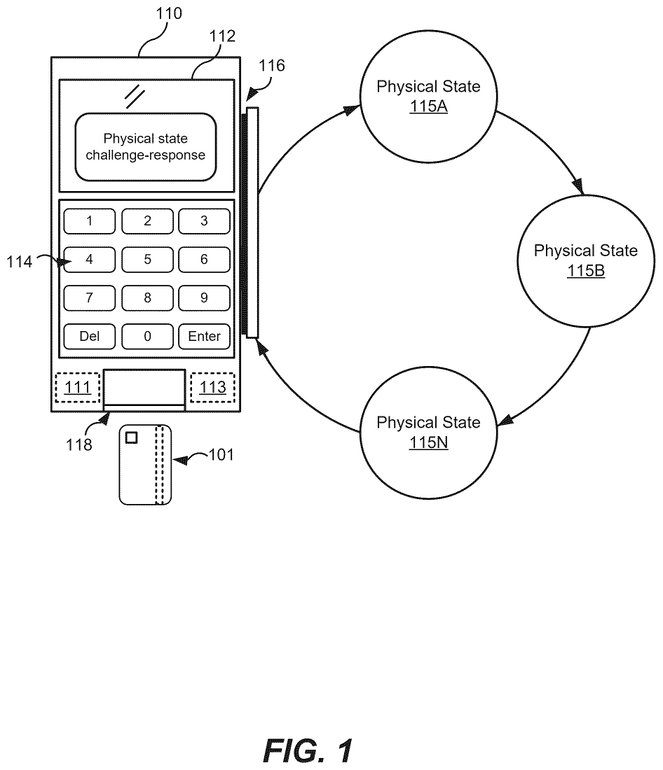

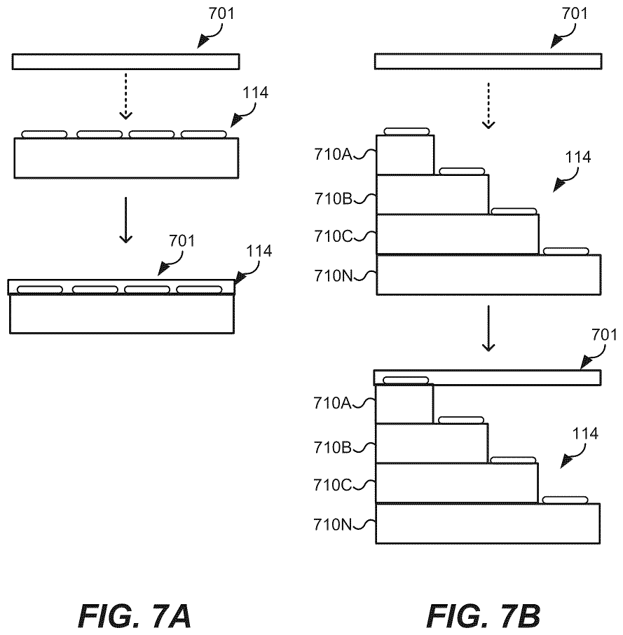

FIG. 1 illustrates an example of a card acceptor device 110 with one or more active anti-skimming countermeasures. The anti-skimming countermeasures may prevent, detect or otherwise mitigate against skimming devices that are placed on or otherwise intended to secretly steal data from the card acceptor device 110. The anti-skimming countermeasures may include active features, an example of which is illustrated in FIG. 1 and/or passive features, an example of which is illustrated in FIG. 7B. Active features alter the physical state 115 (illustrated as one of a plurality of physical states 115A-N) of the card acceptor device 110. A physical state 115 is a configuration of a portion or all of the card acceptor device 110 that can be perceived by a user. For example, a physical state 115 may include a component configuration (such as a layout or height of keys), a shape, a color (whether emitted electronically or otherwise), and/or other physical characteristic of at least a portion of the card acceptor device 110.

The card acceptor device 110 may include a display 112, a keypad 114, a strip reader 116, a DIP reader 118, and/or other components. The anti-skimming countermeasures may be applied to one or more of these or other parts of the card acceptor device 110 to prevent, detect, or otherwise mitigate against skimming devices.

The display 112 may be a touchscreen display or a non-touch display. The keypad 114 may include physical keys for receiving inputs. Usually, the keypad 114 includes numbered keys to receive PIN inputs, although other types of keys including alphabetic, alphanumeric, “Enter”, “Del” may be included. The strip reader 116 reads a magnetic strip from a payment card 101 (if the payment card 101 includes a magnetic strip). The DIP reader 118 may read a chip device or other memory device of the payment card 101 (if the payment card 101 includes a chip device). The components of the card acceptor device 110 are shown for illustration and not limitation. For example, some or all features of the card acceptor device 110 may be included in different form factors and different types of card acceptor devices, such as an ATM, POS device, fuel dispenser, and so forth.

The card acceptor device 110 may further include circuitry such as a processor 111 and a memory 113. The processor 111 may be programmed to operate the components of the card acceptor device 110. In particular, the processor 111 may be configured to implement various anti-skimming countermeasures via one or more of the display 112, the keypad 114, the strip reader 116, the DIP reader 118, and/or other portion of the card acceptor device 110.

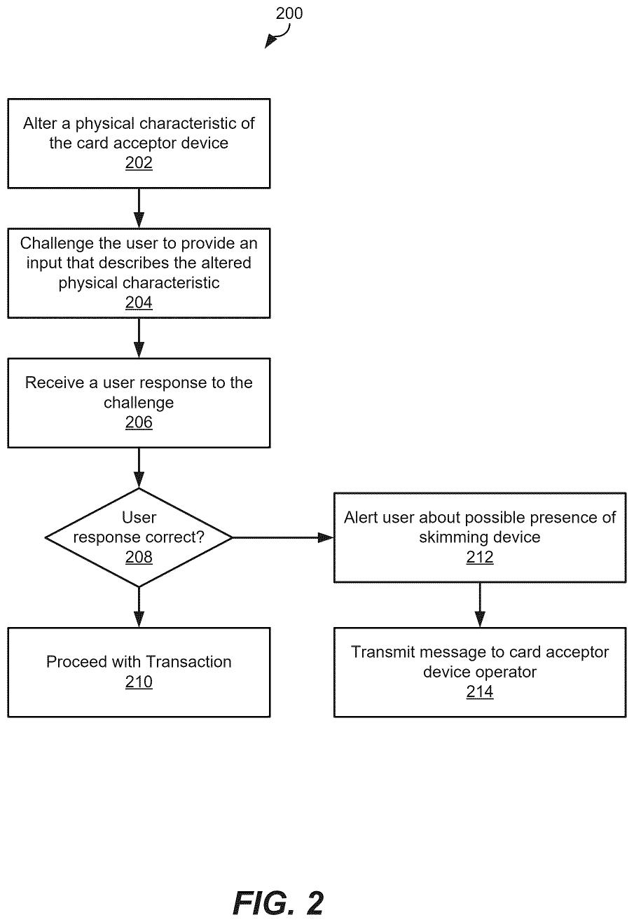

In some examples, the anti-skimming countermeasures may include a challenge-response in which a physical state 115 of the card acceptor device 110 is altered and the user is challenged to provide an input that accurately describes the altered physical state. For example, FIG. 2 illustrates an example of a method 200 of altering a physical state of a card acceptor device 110 and a challenge-response relating to the altered physical state to detect the presence of a skimming device.

At 202, the method 200 may include altering a physical state of the card acceptor device 110. An alteration to a physical state is designed to detect skimming devices. For example, an altered physical state may be designed to detect skimming devices that are molded to fit onto parts of the card acceptor device 110 such as a keypad 114, a strip reader 116, or a DIP reader 118. An incorrect answer suggests that a skimming device is present, while a correct response suggests that a skimming device is not present.

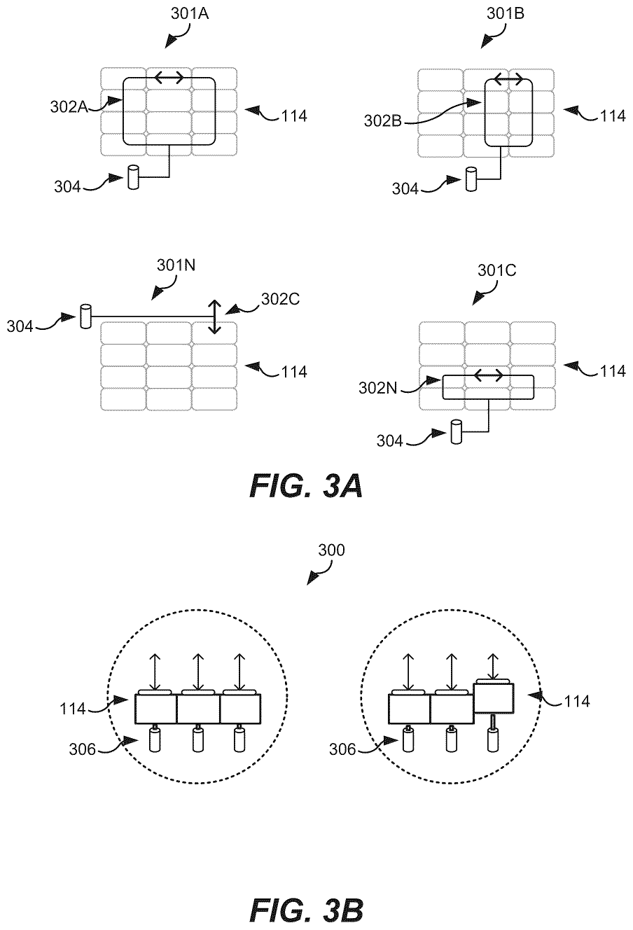

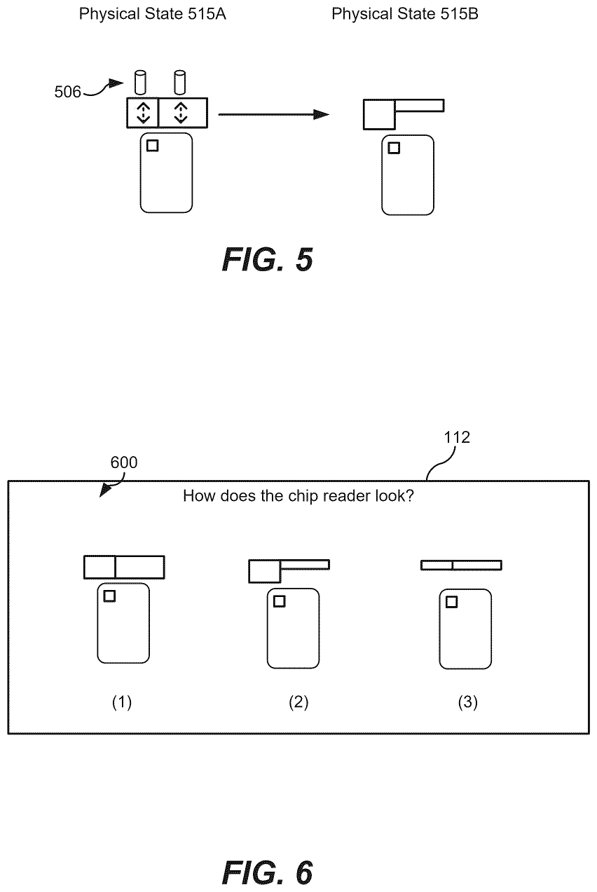

Examples of alterations are illustrated at FIGS. 3A, 3B, and 5. An indication of the alteration made to the card acceptor device 110 may be stored in memory for the challenge-response. In some implementations, before or after the physical state is altered, a lockout may be imposed on the card acceptor device 110 subject to an accurate user response to the challenge-response. The lockout may include software and/or hardware features that prevent a transaction from proceeding. For example, a software lockout may proceed to transaction processing operations only upon receipt of an accurate user response and/or may render softkeys on a touchscreen inoperable. A hardware lockout may impose a physical barrier such as disabling inputs made to the keypad 114, strip reader 116, DIP reader 118, and/or other hardware portion that receives inputs. In one example, the card acceptor device 110 may initiate the software and/or hardware lockout after prompting the user to press an input member to proceed.

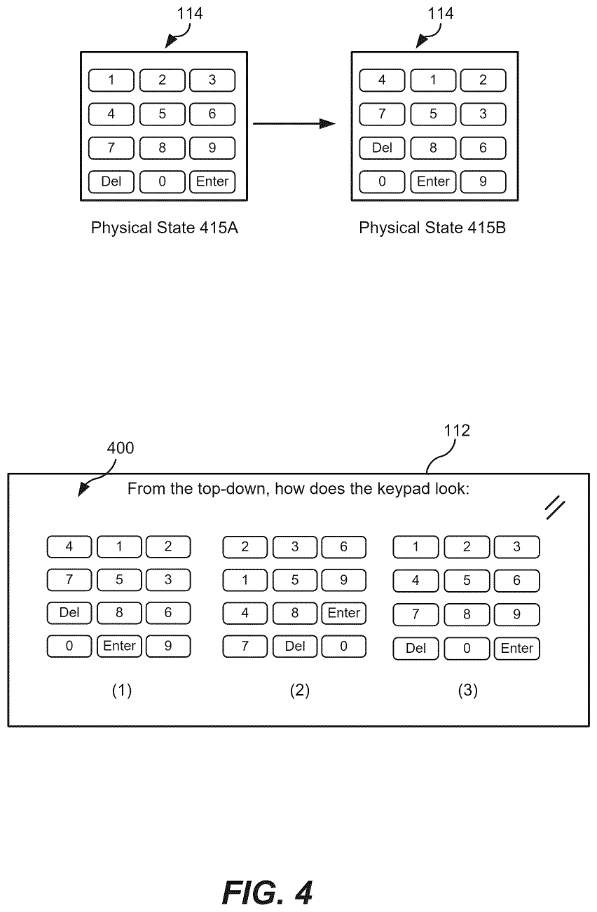

At 204, the method 200 may include challenging the user to provide an input that describes the altered physical state. For example, the method 200 may prompt the user with a multiple choice question, a question with open text input for the answer, and/or other types of challenges. Examples of challenges are illustrated at FIGS. 4 and 6.

At 206, the method 200 may include receiving a user response to the challenge. The user response may indicate whether or not the alteration was detected by the user. If not detected, this suggests that a skimming device is covering or otherwise obscuring all or portion of the part of the card acceptor device 110 that was altered.

At 208, the method 200 may include determining whether the user response is correct. For example, the method 200 may include comparing the user response with the previously stored alteration made to the physical state at 202.

A correct user response suggests there is no skimming device present and the method 200 may proceed to 210, in which the transaction is permitted to proceed. In this example, the method 200 may include generating a skimming device determination that a skimming device is not likely present. For implementations in which a lockout was placed on the card acceptor device 110 prior to the challenge-response, then the lockout is released.

An incorrect user response suggests that the alteration was undetected by the user and was obscured by a skimming device, in which case the method 200 may proceed to 212, which may include alerting the user to the possible presence of the skimming device. Such alert may be made via the display 112, audibly, or otherwise. In this example, the method 200 may include generating a skimming device determination that a skimming device may be present. At 214, the method 200 may transmit a message to a responsible party. The message may include an identification of the card acceptor device 110, an indication that a skimming device is potentially present on the card acceptor device 110, a date/time of the alert, the alteration that was made, the challenge-response, the user response, and/or other information associated with the card acceptor device 110. The responsible party may include the operator of the card acceptor device 110 and/or other users. For implementations in which a lockout was imposed, the lockout may remain until an operator releases the lockout (such as after physically inspecting the card acceptor device 110), after a predefined period of time, and/or after the user indicates a new attempt at a challenge-response is to be made. If a new challenge-response is to be made, the method 200 may be repeated.

FIG. 3A illustrates an example of altering the physical state 115 of a card acceptor device 110 by changing the configuration of the keypad 114, as shown in a top-down view. The example illustrated includes arrangements 301 (illustrated as arrangements 301A-N) of a track 302 (illustrated as track 302A-N). One or more keys in the keypad 114 may be attached to the track 302. In either arrangement 301, each key may be rotated along the track 302 in one or more rotation increments via a motor 104. The motor 104 may include any type of device that is able to move the track, such as a servo motor, a stepper motor, a direct current (DC) motor, an alternating current (AC) motor, a linear motor, a pneumatic motor, and/or other type of motor.

A rotation increment is a unit of rotation one in which each key on the track 302 is rotated to a neighboring key's position. To alter the physical configuration of the card acceptor device 110, the processor 111 may transmit a signal to the motor 304 to generate one or more rotation increments. The number of rotation increments may be random or may be predefined. Alternatively, to alter the physical configuration of the card acceptor device 110, the processor 111 may identify a desired configuration of keys and then transmit a signal to the motor 304 to make the number of rotation increments necessary to change from the current configuration of keys to the desired configuration of keys. The rotation may be made along the same elevational plane as other keys that are not moving.

In arrangement 301A, the track 302A may be attached to the outer keys of the keypad 214. For example, the card acceptor device 110 may rotate the outer keys in a clockwise or counterclockwise direction in one or more rotation increments. In arrangement 301B, the track 302 may be attached to two columns of keys in the keypad to rotate these two columns of keys in a clockwise or counterclockwise direction in one or more rotation increments. In arrangement 301N, the track 302 may be attached to one or more individual keys to slide these along a single axis. In arrangement 301C, the track 302 may be attached to two rows or columns of keys in the keypad to rotate these two rows or columns of keys in a clockwise or counterclockwise direction in one or more rotation increments. Other arrangements 301 of track 302 may be used as well or instead.

FIG. 3B illustrates an example of altering the physical state of a card acceptor device 110 by changing the protrusion, or elevation, of one or more keys in the keypad 114 relative to one or more other keys in the keypad 114, as shown in a side-elevational view. Each key or keys to be moved may be attached to a motor 306 that can change the elevation of the key with respect to at least one other key. The motor 306 may be similar to any of the motors described with respect to motor 304. In some examples, the amount of change in elevation of one or more keys may vary. Such change may be random or predefined, similar to the way in which the rotation increments are defined and executed. In some examples, a first key may be changed to a first elevation while a second key may be changed to a second elevation. In these examples, the challenge may include a question that asks which key is raised the highest (and/or lowest).

FIG. 4 illustrates an example of a prompt 400 in a challenge-response corresponding to an altered physical state 415B using a track arrangement 301A illustrated in FIG. 3A. As illustrated, the keypad 114 is altered from a first physical state 415A to a second physical state 415B by rotating the keypad one rotation increment in a clockwise direction. After this alteration is made, the display 112 may provide the prompt 400. The prompt 400 in this example includes a question that asks the user to select the current layout of the keypad 114. The correct answer (“choice (1)”) shows a keypad layout that is indicative of the second physical state 415B.

FIG. 5 illustrates an example of altering the physical state of a card acceptor device by changing a shape of a DIP reader 118. As illustrated, one or more portions of the DIP reader 118 may be attached to a motor 506 that can retract or extend one or more portions of a card slot of the DIP reader 118. The motor 506 may be similar to any of the motors described with respect to motor 304.

FIG. 6 illustrates an example of a prompt in a challenge-response corresponding to an altered physical state illustrated in FIG. 5. As illustrated, the DIP reader 118 is altered from a first physical state 515A to a second physical state 515B by retracting or extending one or more portions of a card slot. After this alteration is made, the display 112 may provide the prompt 600. The prompt 600 in this example includes a question that asks the user to select the current configuration of the DIP reader 118. The correct answer (“choice (2)”) shows a keypad layout that is indicative of the second physical state 515B.

It should be noted that FIGS. 3A, 3B, and 5 shows examples of alterations to physical states for illustration. Other types of alterations may be made for active anti-skimming. For example, alterations to the color of certain keys or input members may be made in addition to or instead of the illustrated examples. Alterations to the strip reader 116 may be made by extending/retracting or otherwise changing its shape may be made for active anti-skimming as well.

FIG. 7A illustrates an example of a skimming device 701 placed on a keypad 114 having a conventional arrangement of keys on the same side elevational plane, as shown in a side-elevational view. FIG. 7A schematically illustrates how a skimming device 701 is typically molded to fit over the keypad 114 in a way that the user is unaware of its presence.

FIG. 7B illustrates an example of a static anti-skimming countermeasure using a fixed keypad 714 with different elevations, as shown in a side-elevational view. One or more rows or columns 710A-D of keys is fixed at a different elevation than at least one other row so that a skimming device 701 is unable to be placed flush onto the keypad 714 without being noticed. As illustrated, rows or columns 710A-D are each on different elevations with respect to one another, although only one row or column can be on a different elevation and the other rows or columns can be on the same elevation to achieve a static anti-skimming capability. Other types of fixed anti-skimming countermeasures may be used for other parts of a card acceptor device 110. For example, fixed protrusions or other obstacles may be placed on one or more parts of the card acceptor device 110.

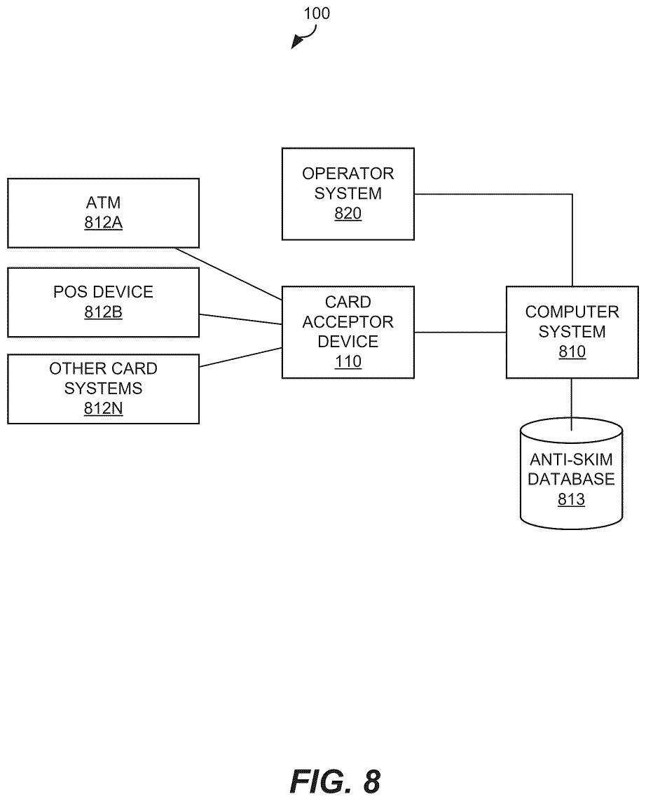

FIG. 8 illustrates an example of a system environment 800 that includes a card acceptor device 110 with anti-skimming countermeasures. The system environment 800 may include a computer system 810, an anti-skim database 813, an operator system 820, a card acceptor device 110, and/or other components. At least some of the components of the system environment 800 may be connected to one another via a communication network, which may include the Internet, an intranet, a Personal Area Network, a LAN (Local Area Network), a WAN (Wide Area Network), a SAN (Storage Area Network), a MAN (Metropolitan Area Network), a wireless network, a cellular communications network, a Public Switched Telephone Network, and/or other network through which system environment 800 components may communicate.

The card acceptor device 110 may be configured as an ATM 812A, a POS device 812B, and/or other types of card systems 812N (such as fuel dispenser machines). In some examples, the card acceptor device 110 may be communicably coupled to the computer system 810 and/or the operator 820. In these examples, the card acceptor device 110 may transmit a log file that includes results of active anti-skimming processing, such as the physical state changes and corresponding challenge-responses that were made and user responses that were received. The card acceptor device 110 may further transmit an alert when a skimming device may be present, such as when an incorrect user response to a challenge-response was received. In this manner, the card acceptor device 110 may be inspected.

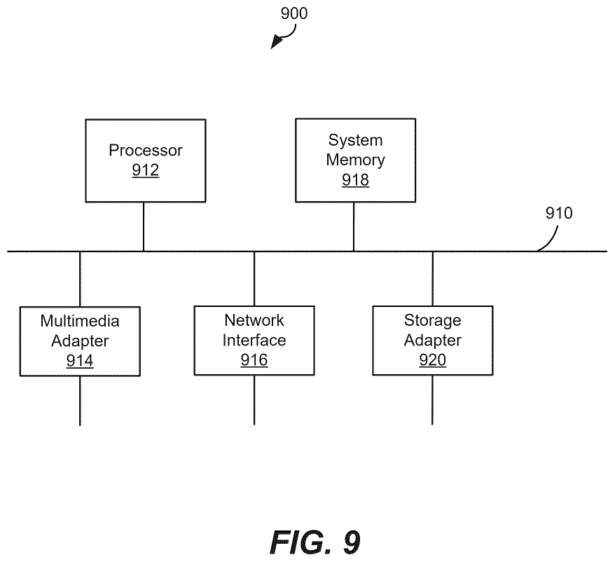

FIG. 9 illustrates an example of a computer system 900 that may be implemented by devices illustrated in FIG. 1. The computer system 900 may be part of or include the system environment 100 to perform the functions and features described herein. For example, various ones of the devices of system environment 100 may be implemented based on some or all of the computer system 900. The computer system 900 may include, among other things, an interconnect 910, a processor 912, a multimedia adapter 914, a network interface 916, a system memory 918, and a storage adapter 920.

The interconnect 910 may interconnect various subsystems, elements, and/or components of the computer system 900. As shown, the interconnect 910 may be an abstraction that may represent any one or more separate physical buses, point-to-point connections, or both, connected by appropriate bridges, adapters, or controllers. In some examples, the interconnect 910 may include a system bus, a peripheral component interconnect (PCI) bus or PCI-Express bus, a HyperTransport or industry standard architecture (ISA)) bus, a small computer system interface (SCPI) bus, a universal serial bus (USB), IIC (I2C) bus, or an Institute of Electrical and Electronics Engineers (IEEE) standard 1384 bus, or “firewire,”or other similar interconnection element.

In some examples, the interconnect 910 may allow data communication between the processor 912 and system memory 918, which may include read-only memory (ROM) or flash memory (neither shown), and random-access memory (RAM) (not shown). It should be appreciated that the RAM may be the main memory into which an operating system and various application programs may be loaded. The ROM or flash memory may contain, among other code, the Basic Input-Output system (BIOS) which controls basic hardware operation such as the interaction with one or more peripheral components.

The processor 912 may control operations of the computer system 900. In some examples, the processor 912 may do so by executing instructions such as software or firmware stored in system memory 918 or other data via the storage adapter 920. In some examples, the processor 912 may be, or may include, one or more programmable general-purpose or special-purpose microprocessors, digital signal processors (DSPs), programmable controllers, application specific integrated circuits (ASICs), programmable logic device (PLDs), trust platform modules (TPMs), field-programmable gate arrays (FPGAs), other processing circuits, or a combination of these and other devices.

The multimedia adapter 914 may connect to various multimedia elements or peripherals. These may include devices associated with visual (e.g., video card or display), audio (e.g., sound card or speakers), and/or various input/output interfaces (e.g., mouse, keyboard, touchscreen).

The network interface 916 may provide the computer system 900 with an ability to communicate with a variety of remote devices over a network. The network interface 916 may include, for example, an Ethernet adapter, a Fibre Channel adapter, and/or other wired-or wireless-enabled adapter. The network interface 916 may provide a direct or indirect connection from one network element to another and facilitate communication to and between various network elements. The storage adapter 920 may connect to a standard computer readable medium for storage and/or retrieval of information, such as a fixed disk drive (internal or external).

Other devices, components, elements, or subsystems (not illustrated) may be connected in a similar manner to the interconnect 910 or via a network. The devices and subsystems can be interconnected in different ways from that shown in FIG. 8. Instructions to implement various examples and implementations described herein may be stored in computer-readable storage media such as one or more of system memory 918 or other storage. Instructions to implement the present disclosure may also be received via one or more interfaces and stored in memory. The operating system provided on computer system 900 may be MS-DOS®, MS-WINDOWS®, OS/2®, OS X®, IOS®, ANDROID®, UNIX®, Linux®, or another operating system.

Throughout the disclosure, the terms “a” and “an” may be intended to denote at least one of a particular element. As used herein, the term “includes” means includes but not limited to, the term “including” means including but not limited to. The term “based on” means based at least in part on. In the Figures, the use of the letter “N” to denote plurality in reference symbols is not intended to refer to a particular number. For example, “115A-N” does not refer to a particular number of instances of 115, but rather “two or more.” The databases (such as the anti-skim database 813) may be, include, or interface to, for example, an Oracle™ relational database sold commercially by Oracle Corporation. Other databases, such as Informix™, DB2 or other data storage, including file-based, or query formats, platforms, or resources such as OLAP (On Line Analytical Processing), SQL (Structured Query Language), a SAN (storage area network), Microsoft Access™ or others may also be used, incorporated, or accessed. The database may comprise one or more such databases that reside in one or more physical devices and in one or more physical locations. The database may include cloud-based storage solutions. The database may store a plurality of types of data and/or files and associated data or file descriptions, administrative information, or any other data. The various databases may store predefined and/or customized data described herein.

The systems and processes are not limited to the specific embodiments described herein. In addition, components of each system and each process can be practiced independently and separate from other components and processes described herein. Each component and process may also be used in combination with other assembly packages and processes. The flow charts and descriptions thereof herein should not be understood to prescribe a fixed order of performing the method blocks described therein. Rather the method blocks may be performed in any order that is practicable including simultaneous performance of at least some method blocks. Furthermore, each of the methods may be performed by one or more of the system components illustrated in the figures, such as FIGS. 1 and 8.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

As will be appreciated based on the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. Example computer-readable media may be, but are not limited to, a flash memory drive, digital versatile disc (DVD), compact disc (CD), fixed (hard) drive, diskette, optical disk, magnetic tape, semiconductor memory such as read-only memory (ROM), and/or any transmitting/receiving medium such as the Internet or other communication network or link. By way of example and not limitation, computer-readable media comprise computer-readable storage media and communication media. Computer-readable storage media are tangible and non-transitory and store information such as computer-readable instructions, data structures, program modules, and other data. Communication media, in contrast, typically embody computer-readable instructions, data structures, program modules, or other data in a transitory modulated signal such as a carrier wave or other transport mechanism and include any information delivery media. Combinations of any of the above are also included in the scope of computer-readable media. The article of manufacture containing the computer code may be made and/or used by executing the code directly from one medium, by copying the code from one medium to another medium, or by transmitting the code over a network.

This written description uses examples to disclose the embodiments, including the best mode, and to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A card acceptor device with anti-skimming, comprising:
a processor programmed to:
cause a physical state of the card acceptor device to change from a first physical state to a second physical state;
prompt a user to identify a current physical state of the card acceptor device;
receive a user response to the prompt;
determine whether the user response correctly identifies the current physical state; and
generate a skimming device determination based on the determination of whether the user response correctly identifies the current physical state.

2. The card acceptor device of claim 1, further comprising a keypad having one or more movable keys, and wherein to cause the physical state of the card acceptor device to change, the processor is further programmed to:
cause one or more of the movable keys to move.

3. The card acceptor device of claim 2, wherein to cause the one or more movable keys to move, the processor is further programmed to:
cause the one or more movable keys to move along an elevational plane that is the same as other keys that are not moved.

4. The card acceptor device of claim 2, wherein to cause the one or more movable keys to move, the processor is further programmed to:
cause the one or more movable keys to move along a different elevational plane with respect to at least one other key.

5. The card acceptor device of claim 1, wherein to cause the physical state of the card acceptor device to change, the processor is further programmed to:
change a color of at least one part of the card acceptor device.

6. The card acceptor device of claim 1, wherein the processor is further programmed to:
require, before the prompt, the user to initiate a challenge-response in order to proceed with a transaction.

7. The card acceptor device of claim 1, wherein the processor is further programmed to:
apply a lock to prohibit further transaction processing unless the user response is correct.

8. The card acceptor device of claim 7, wherein the processor is further programmed to:
determine that the user response is correct; and
release the lock responsive to the determination that the user response is correct.

9. The card acceptor device of claim 1, wherein the processor is further programmed to:
determine that the user response is incorrect; and
transmit an alert to a responsible party responsive to the determination that the user response is incorrect.

10. A method, comprising:
causing, by a card acceptor device, a physical state of the card acceptor device to change from a first physical state to a second physical state;
prompting, by the card acceptor device, a user to identify a current physical state of the card acceptor device;
receiving, by the card acceptor device, a user response to the prompt;
determining, by the card acceptor device, whether the user response correctly identifies the current physical state; and
generating, by the card acceptor device, a skimming device determination based on the determination of whether the user response correctly identifies the current physical state.

11. The method of claim 10, further comprising a keypad having one or more movable keys, and wherein causing the physical state of the card acceptor device to change comprises:
causing one or more of the movable keys to move.

12. The method of claim 11, wherein causing the one or more movable keys to move comprises:
causing the one or more movable keys to move along an elevational plane that is the same as other keys that are not moved.

13. The method of claim 11, wherein causing the one or more movable keys to move comprises:
causing the one or more movable keys to move along a different elevational plane with respect to at least one other key.

14. The method of claim 10, wherein causing the physical state of the card acceptor device to change comprises:
changing a color of at least one part of the card acceptor device.

15. The method of claim 10, further comprising:
requiring, before the prompt, the user to initiate a challenge-response in order to proceed with a transaction.

16. The method of claim 10, further comprising:
applying a lock to prohibit further transaction processing unless the user response is correct.

17. The method of claim 16, further comprising:
determining that the user response is correct; and
releasing the lock responsive to the determination that the user response is correct.

18. The method of claim 16, further comprising:
determining that the user response is incorrect; and
transmitting an alert to a responsible party responsive to the determination that the user response is incorrect.

19. A card acceptor device with one or more passive anti-skimming countermeasures, comprising:
a keypad having a plurality of input keys, wherein at least a first set of input keys from among the plurality of input keys is arranged at a first elevation and at least a second set of input keys from among the plurality of input keys is arranged at a second elevation higher than the first elevation to prevent a skimming device from sitting flush onto the keypad.

20. The card acceptor device of claim 19, wherein the input keys of the keypad are arranged into a plurality of rows and/or columns, each row or column having at least one input key, and wherein each row or column is formed to be at a respective elevation that is different than other rows or columns in the keypad.
